(19) United States
(12) Patent Application Publication
(10) Pub. No.: US 2013/0157511 A1
(43) Pub. Date: Jun. 20, 2013

(54) CONNECTION FOR A TWO-POLE ELECTRICAL DEVICE

(71) Applicants: Joseph Burkiett, Fairview, IL (US); Paul Casperson, Peoria, IL (US); Christian Hagen, Lewistown, IL (US)

(72) Inventors: Joseph Burkiett, Fairview, IL (US); Paul Casperson, Peoria, IL (US); Christian Hagen, Lewistown, IL (US)

(73) Assignee: Caterpillar Inc., Peoria, IL (US)

(21) Appl. No.: 13/330,729

(22) Filed: Dec. 20, 2011

(51) Int. Cl. H01R 24/38

(52) U.S. Cl. 439/626; 439/625

(57) ABSTRACT

The disclosure relates to a two-pole electrical device having a two conductor that allows for universal radial orientation of a mating connector and harness. A mating connector for the two-pole electrical device is also disclosed. The mating connector is fastened to the two-pole electrical device in a way to ensure secure connection in automotive and heavy duty applications.

### TECHNICAL FIELD

The disclosure is directed to a two-pole electrical device, more particularly to the connector terminals and orientation of a two-pole electrical device.

### BACKGROUND

Two pole electrical devices are commonly used throughout the electrical arts. Examples of two-pole electrical devices are switches, capacitors, resistors, batteries, solenoids, relays, or other devices known in the art. Each of these two-pole electrical devices requires a wire connection. The wire connection is achieved by attaching the wire to a terminal of the two-pole electrical device. See for example Solenoid Stator Assembly for Electronically Actuated Fuel Injector to Anh Pham, U.S. Pat. No. 5,339,063.

One problem with the commonly used two terminal design is that of connector orientation. Depending on the installed orientation of the two-pole electrical device, the mating connector and harness may be required to be twisted in order to make a proper connection. Twisting the harness may cause undesired stress on the harness and connector components, leading to premature failure.

### SUMMARY OF THE INVENTION

In one aspect of the disclosure, a two-pole electrical device is shown. The device includes a center conductor, an outer conductor, the center conductor and the outer conductor being secured by a case, wherein the outer conductor is radially disposed about the center conductor.

In another aspect of the disclosure, an electrical connector for a two-pole electrical device is shown. The device includes a center terminal including a center terminal hole, an outer terminal including an outer terminal hole, wherein said center terminal hole and said outer terminal hole are aligned axially and said center terminal and said outer terminal are separated by insulator, for providing an electrical connection to a two-pole electrical device.

### BRIEF DESCRIPTION OF THE DRAWINGS

FIG. 1 is a view of a two-pole electrical device.

FIG. 2 is a view of a two-pole electrical device with an alternative conductor.

FIG. 3 is a view of a two-pole electrical device with a threaded center conductor for accepting a threaded fastener.

FIG. 4 is a view of a two-pole electrical device with a radiused slot for accepting a fastener clip.

FIG. 5 is a view of a two-pole electrical device joined to a mating connector.

FIG. 6 is a view of a mating connector.

### DETAILED DESCRIPTION

The external features of a two-pole electrical device 10 consist of a case 40 and two conductors 20 and 30. The internal components of the device could be a switch, capacitor, resistor, battery, solenoid, relay, or other device known in the art. The details of the internal components are not relevant to this disclosure and will not be discussed further.

The case 40 is made from a non-conducting material such as plastic and serves to provide electrical insulation between the center conductor 20 and outer conductor 30. The case could be assembled from multiple pieces or constructed as an overmold of the internal components. The overmold could consist of such materials as urethane, polyimide hot-melt, polyester, or ABS.

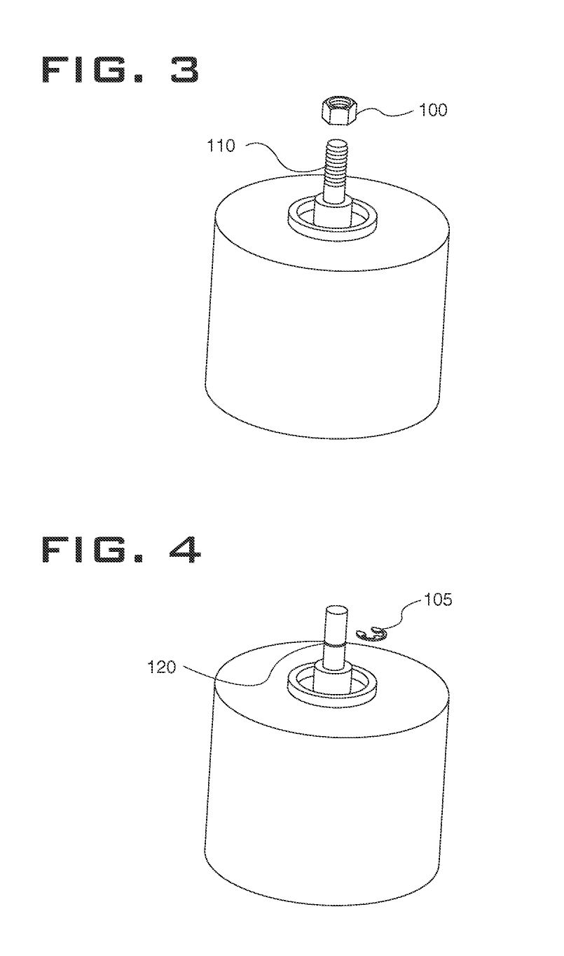

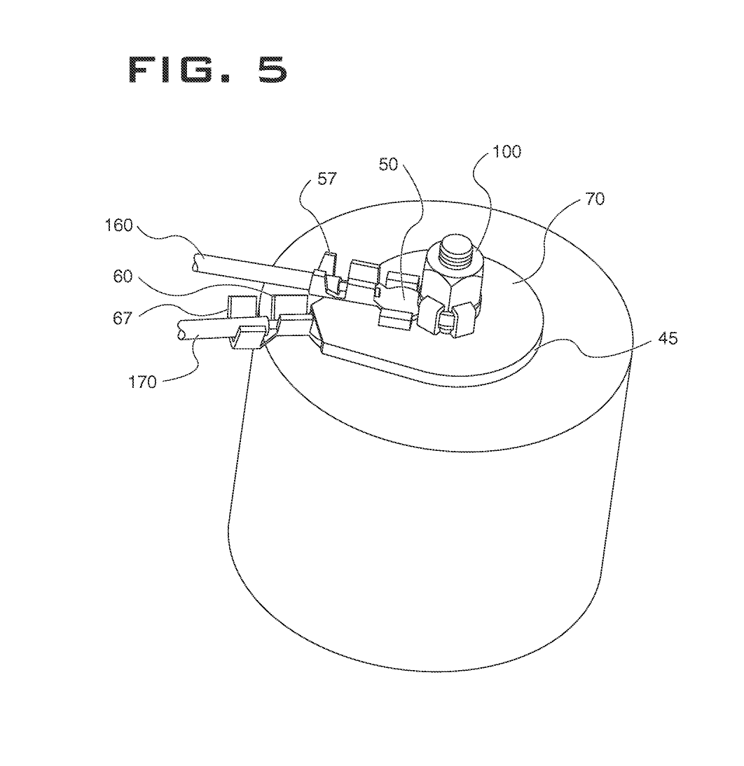

The center conductor 20 and outer conductor 30 are made of conductive material and serve to conductively transmit current from the wire conductors 160 and 170 to the internal components of the two-pole electrical device 10. The center conductor 30 takes the form of a post and is provided with a means for fastening to a mating connector 45. One method for fastening, shown in FIG. 3, is to provide threads in the center conductor 20 that mate to a threaded fastener 100 such as a nut. Another method for fastening, shown in FIG. 4, is to provide a radiused slot, or chamfer, 120 in the center conductor that mates with a fastening clip 105. Other fastening methods known in the art could also be used. The center conductor 20 could also have a larger diameter lower conductor portion 130 which has a lower conductor portion land 140. The lower conductor portion 130 provides additional strength to the center conductor, if needed. The lower conductor portion land 140 provides additional surface area for clamping load and electrical conduction.

The outer conductor 30 is radially disposed about the center conductor 20. The portion protruding above the case 40 has a generally cylindrical cross section. The top of the cylindrical cross section forms the outer conductor mating surface 35. The outer conductor 30 is conductively connected to one of the poles of the internal component housed in the case 40.

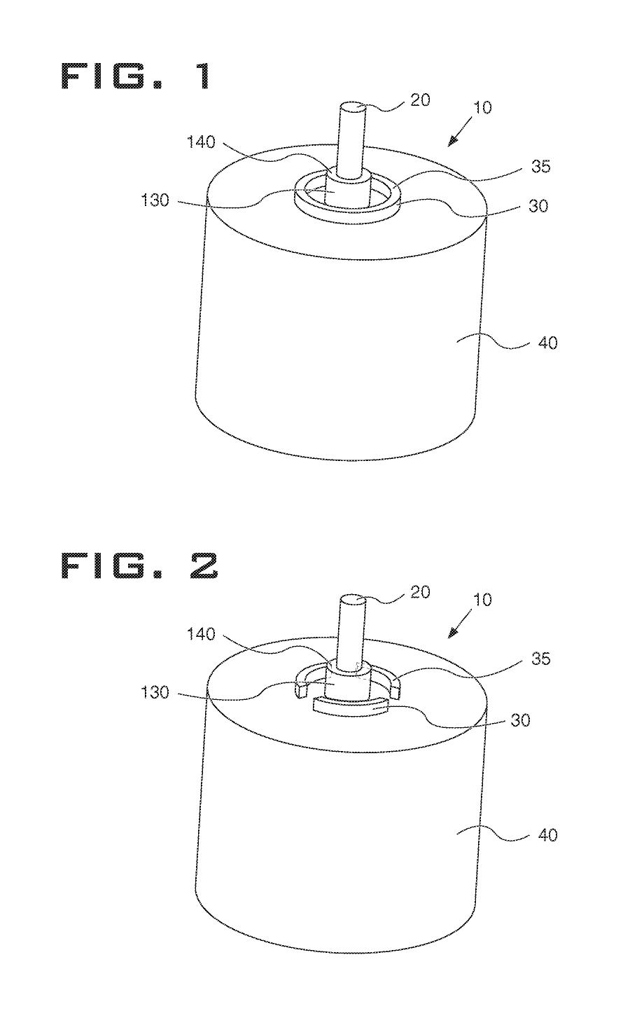

Although the outer conductor 30 is shown having a cylindrical cross section as shown in FIG. 1, it should be recognized that the outer conductor 30 could have various other configurations. FIG. 2 shows the outer conductor 30 having three equally-spaced protrusions, each having an outer conductor mating surface 35. The number of protrusions can be chosen to adapt to clamping load and conductivity requirements.

The conductors 20, 30 of the two-pole electrical device are designed to be joined to a mating connector 45. The mating connector includes a center terminal 50 and an outer terminal 60. The center terminal 50 and outer terminal 60 include center terminal hole 51 and outer terminal hole 61 respectively. The center terminal 50 and outer terminal 60 are radially aligned about holes 51 and 61 and are separated by insulator 70. Terminals 50 and 60 may be attached to insulator 70. Center terminal 50 may include a connection feature 57 that conductively attaches to a first wire conductor 160. Likewise, outer terminal 60 may include a connection feature 67 that conductively attaches to a second wire conductor 170. Once the conductors 20, 30 of the two-pole electrical device 10 and the mating connector 45 have been joined, they are fastened into place by a fastener clip 105, a threaded fastener 100, or the like. A preload device such as a wave washer or other spring may be used between the two-pole electrical device 10 and the mating connector 45. The features of the two-pole electrical device and the mating connector have been chosen provide a secure connection in the vibration and shock of automotive and heavy duty applications.

### INDUSTRIAL APPLICABILITY

An example of a two-pole electrical device 10 set forth in this disclosure may be a solenoid for actuating a fuel injector. Such solenoids typically have two conductors 20, 30 for connecting to the mating connector 45. The two-pole electrical device 10 and mating connector 45 set forth in this disclosure allows for changes in the solenoid mounting orientation without need to twist the mating connector 45 in order to make the connection. This allows the conductors 160, 170 to be routed according to their design (clearance, vibration, etc.) without the concern of twisting to mate to the solenoid.

What is claimed is:

1. A two-pole electrical device comprising:
a center conductor,
an outer conductor,
the center conductor and the outer conductor being secured by a case,
wherein the outer conductor is radially disposed about the center conductor.

2. The two-pole electrical device of claim 1 wherein the center conductor 20 includes threads to accept a fastener.

3. The two-pole electrical device of claim 1 wherein the center conductor includes a radiused slot to accept a fastener clip.

4. The two-pole electrical device of claim 1 wherein the center conductor includes a lower conductor portion having a lower conductor portion land.

5. The two-pole electrical device of claim 1 wherein the outer conductor is non-continuous with plural mating surfaces.

6. The two-pole electrical device of claim 5 wherein the center conductor includes threads to accept a fastener.

7. The two-pole electrical device of claim 5 wherein the center conductor includes a radiused slot to accept a fastener clip.

8. The two-pole electrical device of claim 5 wherein the center conductor includes a lower conductor portion having a lower conductor portion land.

9. An electrical connector for a two-pole electrical device comprising:
a center terminal including a center terminal hole,
an outer terminal including an outer terminal hole,
wherein said center terminal hole and said outer terminal hole are aligned axially
and said center terminal and said outer terminal are separated by insulator, for providing an electrical connection to the two-pole electrical device set forth in
claim 1.
